(19) United States
(12) Patent Application Publication
(10) Pub. No.: US 2012/0276451 A1
(43) Pub. Date: Nov. 1, 2012

(54) METHOD FOR PREPARING AN ELECTRODE COMPOSITION

(76) Inventors: Bernard Lestriez, Nantes (FR); Dominique Guyomard, Sautron (FR); Driss Mazouzi, Nantes (FR); Lionel Roue, Sainte-Julie (CA)

(21) Appl. No.: 13/146,239

(22) PCT Filed: Jan. 28, 2010
(86) PCT No.: PCT/FR10/50135

§ 371 Date: Nov. 30, 2011

(30) Foreign Application Priority Data
Jan. 30, 2009 (FR) 0900410

(51) Int. Cl. H01M 4/38; H01M 4/62; H01M 4/88; H01M 4/583; B82Y 99/00

(52) U.S. Cl. 429/217; 252/512; 252/500; 252/503; 252/511; 977/742; 977/948

(57) ABSTRACT

A method for preparing an electrode composition, including a step of forming a suspension, in an unbuffered aqueous acid medium having a pH of 1 or in a buffered acid medium having a pH less than or equal to 4, containing an electrode active material in the form of particles of an element M selected from Si, Sn, and Ge, a polymer binder having reactive groups capable of reacting with hydroxyl groups in an acid medium, and an agent generating electronic conductivity. The invention also relates to the electrode obtained according to the method, as well as to a battery including such an electrode.

The present invention relates to a composition for producing a negative composite electrode of a lithium-ion battery, to a process for producing the composition and the electrode, and to a battery comprising said electrode.

A lithium-ion battery comprises at least one negative electrode or anode and at least one positive electrode or cathode, between which is placed a separator impregnated with an electrolyte. The electrolyte is formed from a lithium salt dissolved in a solvent chosen so as to optimize the transport and dissociation of the ions.

In a lithium-ion battery, each of the electrodes generally comprises a current collector on which is deposited a composite material that comprises a material that is active toward lithium, a polymer that acts as binder (for example a vinylidene fluoride copolymer (PVdF), and an agent for imparting electron conduction (for example carbon black). During the functioning of the battery, lithium ions pass from one of the electrodes to the other through the electrolyte. During discharge of the battery, an amount of lithium reacts with the active material of the positive electrode from the electrolyte, and an equivalent amount is introduced into the electrolyte from the active material of the negative electrode, the lithium concentration thus remaining constant in the electrolyte. The insertion of lithium into the positive electrode is compensated for by the supply of electrons from the negative electrode via an external circuit. During charging, the inverse phenomena take place.

Li-ion batteries are used in many devices that comprise portable appliances, especially such as cellular telephones, computers and light tools, or heavier appliances such as two-wheel transportation means (bicycles, mopeds) or four-wheel transportation means (electrical or hybrid motor vehicles). For all these applications, it is imperative to have batteries that have the highest possible energy density per unit mass (Wh/kg) and energy density per unit volume (Wh/L). In the commercial Li-ion batteries used in cellular telephones, computers and light tools, the active material of the negative electrode is generally graphite and the active material of the positive electrode is cobalt oxide. The energy density per unit mass of Li-ion batteries based on this couple is 200 Wh/kg. Such batteries are not safe enough to be used for transportation applications. The marketed Li-ion batteries for applications relating to transportation have graphite as active material at the negative electrode and iron phosphate at the positive electrode, and their energy density per unit mass is 110 Wh/kg.

The theoretical capacitance of graphite is 372 mAh/g of graphite, whereas those of Si and of Sn are, respectively, 3580 mAh/g of Si and 1400 mAh/g of Sn. The use of Si or Sn in place of graphite would thus make it possible to obtain the same capacitance with a smaller volume, or greater capacitance with the same volume of material. Thus, replacing graphite with silicon in Li-ion batteries would make it possible to achieve an energy density of 320 Wh/kg for portable applications and of 180 Wh/kg in applications in the transportation field.

The use of an active material such as Si, Sn or Ge has, however, a drawback, due to the fact that the large variations in volume (up to 300%) of the Si particles to caused by charging and discharging lead to mechanical constraints and losses of cohesion of the electrode. This loss is accompanied over time by a very great decrease in the capacitance and an increase in the internal resistance. N. Obrovac, L. Christensen, Electrochem. Solid-State Lett., 2004, 7, A93). This drawback is more limited for thin Si films, which may show good cyclability (3600 mAh.g⁻¹ after 200 cycles for a 250 nm film of Si, but which have a low surface capacitance (less than 0.5 mAh.cm⁻²) on account of their small thickness [T. Takamura, S. Ohara, M. Uehara, J. Suzuki, K. Sekine, J. Power Sources, 2004, 129, 96], However, the high cost associated with the process for depositing these thin films limits their commercial development for all portable and transportation applications. [U. Kasavajjula, C. Wang, A. J. Appleby, J. Power Sources, 2007, 163, 1003].

For portable applications, thick negative electrodes, which have a surface capacitance of 3.0 mAh.cm⁻² are obtained by mixing Si particles with an electron-conducting agent (for example carbon black) and a polymeric binder (for example PVdF). The poor cyclability of these electrodes is due to the collapse of the network formed by the carbon black and the loss of Si/carbon contacts on account of the expansion and then contraction of the Si particles and also of their fracture into very small particles during the formation of alloys with lithium, [J. H. Ryu, J. W. Kim, Y.-E. Sung, S. M. Oh, Electrochem. Solid-State Lett., 2004, 7, A306; W.-R. Liu, Z.-Z. Guo, W.-S. Young, D.-T. Shieh, H.-C. Wu, M.-H. Yang, N.-L. Wu, J., Power Sources, 2005, 140, 139], The loss of the carbon/carbon and Si/carbon contacts limits the electron transport in the anode and consequently the alloy reaction.

To overcome these drawbacks, it has been proposed to use manometric silicon particles [U. Kasavajjulta, C. Wang, A. J. Appleby, J., Power Sources, 2007, 163, 1003; Z. P. Guo, J. Z. Wang, H. K. Liu, S. X. Dou, J., Power Sources, 2005, 146, 448], or composite particles of Si and of various conductive materials (prepared, for example, by decomposition of organic precursors, via chemical vapor deposition (CVD), via mechanochemical grinding, via simple physical mixing, or via the reaction of gels) [U, Kasavajjula, C. Wang, A. J. Appleby, J. Power Sources, 2007 which is a review on silicon]. Nanostructured active materials have also been proposed [M. Holzapfel, H. Buqa, W. Scheifele, P. Novak, F.-M. Petrat, Chem. Commun., 2005, 1566], or conductive agents such as carbon nanotubes or carbon nanofibers [S. Park, T. Kim, S. M. Oh, Electrochem. Solid-State Lett, 2007, 10, A142.]. However, none of these means makes it possible to obtain a large improvement in the performance of the negative electrode. The best cycling stability is limited to 400 cycles with an electrode that has a capacitance of 425 mAh/g of electrode [M. Yoshio, S. Kugino, N. Dimov, J. Power Sources, 2006, 153, 375 and M. Yoshio, T. Tsumura, N. Dimov, J. Power Sources, 2007, 163, 215].

It has also been proposed to prepare a composite material containing micrometric Si particles as active material, a carboxymethylcellulose as binder and carbon black as agent for imparting electron conductivity, in a medium at pH 3 [(B. Lestriez, S. Bahri, I. Sandu, L. Roue, D. Guyomard, Electrochemistry Communications, 2007, 9, 2801-2806].

However, various prior-art publications relate to processes for preparing composite electrode materials in which implementation in acidic medium is not recommended. Mention may be made in this respect of W. Porcher, et al. [Electrochemical and Solid-State Letters, 2008, 1, A4-A8] according to which the production in acidic aqueous solution of a positive electrode based on LiFePO₄ is harmful if the active material dissolves at acidic pH; J-H. Lee, et al., [J. Power Sources, 2005, 147, 249-255] according to which it is preferable to prepare a negative electrode based on graphite and carboxymethylcellulose (CMC) in a pH range>6, since, at an acidic pH the electrode suspension is not stable on account of neutralization of the COO⁻ carboxylate functions of the CMC to carboxylic functions COOH; and C-C. Li, et al., [J. Mater. Sci., 2007, 42, 5773] according to which it is preferable to prepare a positive electrode based on LiCoO₂ and CMC in a pH range>7, since, at an acidic pH, the electrode suspension is not stable, which is reflected by inferior electrochemical performance. Neutralization of the carboxylate functions COO⁻ of CMC to carboxylic functions COOH brings about a loss of its shear-thickening properties, these properties being the reason for its use in aqueous electrode suspensions.

The inventors have found, surprisingly, that when a composite electrode is prepared from a composition formed by a mixture of submicron particles of an active material M (Si, Sn or Ge), of carbon particles and of a polymer, under certain pH conditions and relative proportions of the various constituents of the mixture, a battery is obtained that has improved properties in terms of conservation of capacitance on charging and discharging over successive cycles, when said composition is produced in acidic medium. Without wishing to be bound by any theory, the inventors think that these improved properties result especially from improved mechanical strength.

The aim of the present invention is to provide a composition for producing a negative electrode that is intended to be used in a lithium-ion battery, to a process for producing said composition and the electrode, and also to a battery comprising such a negative electrode.

A composition according to the invention is prepared via a process comprising a step of suspending in an aqueous medium an active electrode material, a binder and an agent for generating electron conductivity. Said process is characterized in that
the electrode active material is in the form of particles containing an element M chosen from Si, Sn, Ge; said particles having a mean size of less than 1 μm;
the binder is a polymer that bears reactive groups capable of reacting with hydroxyl groups in acidic medium;
the aqueous medium is an unbuffered acidic medium at pH 1, or a buffered acidic medium at a pH of less than or equal to 4, Obtained by adding a strong base and an organic acid;
the total amount of “active material, binder, electron-conducting agent” constituents introduced into the acidic aqueous medium is from 10% to 80% by weight of the total amount of the composition, and the proportions of said constituents in the aqueous medium are as follows:
   30% to 90% by weight of particles of active material;
   5% to 40% by weight of binder;
   5% to 30% by weight of electron conductivity agent,
the amount of organic acid is such that it corresponds to a content of greater than 0.5×10⁻⁴ mol per gram of element M, and the mass ratio

$$\frac{organic acid + strong base}{\begin{matrix}organic acid + strong base + M + binder + \\ electron \text{-} conducting agent\end{matrix}}$$

remains less than or equal to 20%, i.e. (d+e)/(a+b+c+d+e)≦0.1, the letters a, b, c, d and e denoting, respectively, the amounts of active material, binder, electron-conducting agent, acid and base.

The particles of active material preferably have a mean size of less than 200 nm. Silicon is particularly preferred as active material.

The particles of active material may be formed by an element M alone, an alloy of M with Li, or by a composite material comprising the element M or the alloy M-Li and a conductive material Q.

When the active material is in the form of composite particles, it may be to obtained by various processes, especially by decomposition of organic precursors in the presence of M, by CVD deposition, by mechanochemical grinding, by simple physical mixing, by reaction of gels, or by nanostructuring. The conductive material Q may be carbon in various forms, for example in the form of amorphous carbon, graphite, carbon nanotubes or carbon nanofibers. The conductive material Q may also be a metal that does not react with lithium, for example Ni or Cu.

The polymer used as binder is advantageously chosen from polymers that are electrochemically stable in the potential window 0-5 V relative to Li⁰/Li⁺, which are insoluble in the liquid media that may be used as liquid electrolyte solvent, and which bear functions that are capable of reacting with OH groups in acidic medium, especially carboxyl, amine, alkoxysilane, phosphonate and sulfonate groups. Examples of polymers that may be mentioned in particular include acrylic acid copolymers, acrylamide copolymers, styrenesulfonic acid copolymers, maleic acid copolymers, itaconic acid copolymers, fignosulfonic acid copolymers, allylamine copolymers, ethaciylic acid copolymers, polysiloxanes, epoxyamine polymers, polyurethanes and carboxymethylcelluloses (CMC). CMCs are particularly preferred.

The agent that generates electron conductivity may be chosen from carbon black, SP carbon, acetylene black, carbon nanofibers and carbon nanotubes.

According to one preferred embodiment of the invention, the amount of organic acid is such that it corresponds to a content of greater than 5×10⁻⁴ mol per gram of element M and the mass ratio

$$\frac{organic acid + strong base}{\begin{matrix}organic acid + strong base + M + binder + \\ electron \text{-} conducting agent\end{matrix}}$$

remains less than or equal to 10%.

The total amount of the “active material, binder and electron-conducting agent” constituents introduced into the acidic aqueous medium is preferably from 20% to 60% by weight of the total amount of the composition.

When the element M is in the form of particles, the particles have an oxide layer over at least part of their surface. The pH of the composition which contains them must be acidic enough for the oxide at the surface of the particles of M to be essentially in the form of groups MOH and in order for the reactive functions of the polymer acting as binder to be essentially in the form of COOH, NH, PO₃H₂, Si—(OH)₃ and SO₃H groups.

The acidic aqueous medium may be obtained by adding to water either a strong acid in an amount sufficient to obtain an initial pH of 1, or by using a buffered aqueous solution at a pH of less than or equal to 4. The buffered aqueous solution is obtained by adding to water a mixture of organic acid and a strong base in sufficient amount. It is particularly advantageous to use an “organic acid/strong base” mixture, which makes it possible to keep the pH constant during the transformation of the oxide of M into MOH, so as to conserve the reactive groups of the polymeric binder in acidic form. Simple addition of a strong acid would involve the use of larger initial amounts of acid, which would have the drawback of causing irreversible degradation of the various constituents of the electrode and of the current collector when the material is used as an electrode material.

The strong base is advantageously an alkali metal hydroxide. The organic acid is chosen from weak acids, in particular glycine, aspartic acid, bromoethanoic acid, bromobenzoic acid, chloroethanoic acid, dichloroethanoic acid, trichloroethanoic acid, lactic acid, maleic acid, malonic acid, phthalic acid, isophthalic acid, terephthalic acid, picric acid, salicylic acid, formic acid, acetic acid, oxalic acid, malic acid, fumaric acid and citric acid. Citric acid is particularly preferred.

A negative electrode according to the present invention is formed by a composite material on a conductive substrate. It is produced by applying to said conductive substrate a composition according to the present invention as defined above, followed by drying the deposited composition.

The conductive substrate, intended to form the current collector of the electrode, is preferably a sheet of a conductive material, for example a sheet of copper, nickel or stainless steel. Copper is particularly preferred.

After depositing the composition on the conductive substrate, drying may be performed via a process comprising a step of drying in air at ambient temperature, followed by a step of drying under vacuum with heating to a temperature of between 70 and 150° C. A temperature of about 100° C. is preferred.

The electrode obtained comprises a layer of composite material on a conductive substrate serving as collector. The conductive substrate is as defined previously.

The proportions of the constituents of the composite material are such that:
30% to 90% by weight of active material particles;
5% to 40% by weight of binder;
5% to 30% by weight of electron conductivity agent;
an amount f of the salt of the base and of the organic acid;
   it being understood that f/(a+b+c+f)≧0.2, a, b and c having the meaning indicated previously, and f is less than 20% by weight and preferably less than 10%.

In one particular embodiment, the element M of the initial composition is Si, such that the active material of the composite electrode is Si.

In another particular embodiment, the element M is in the form of nanoparticles.

The compositions that are preferred in particular are those in which the element M is Si in the form of nanoparticles.

Particular examples of compositions are as follows:
80% by mass of silicon particles, 8% by mass of CMC binder, 12% by mass of acetylene black,
76.25% by mass of silicon particles, 8% by mass of CMC binder, 11% by mass of acetylene black, 4.35% by mass of citric acid and 0.4% by mass of KOH,
50% by mass of silicon particles, 25% by mass of CMC binder, 15.5% by mass of acetylene black, 8.7% by mass of citric acid and 0.8% by mass of KOH,
72.3% by mass of silicon particles, 7.2% by mass of CMC binder, 10.8% by mass of acetylene black, 8.7% by mass of citric acid and 0.9% by mass of KOH.

The electrode composite material according to the invention has improved properties, especially as regards the mechanical strength, the resistance to degradation by an electrolyte, and the thickness of the passivation layer on the active material.

A lithium-ion battery comprising an electrode according to the present invention constitutes another subject of the present invention.

A lithium-ion battery according to the present invention comprises at least one negative electrode and at least one positive electrode between which is placed a solid electrolyte (polymeric or vitreous) or a separator impregnated with a liquid electrolyte. It is characterized in that the negative electrode is an electrode according to the invention.

The positive electrode is formed by a current collector bearing a material that is capable of reversibly inserting lithium ions at a potential greater than that of the material of the negative electrode. This material is generally used in the form of a composite material also comprising a binder and an agent that generates electron conductivity. The binder and the electron conductivity agent may be chosen from those mentioned for the negative electrode. The material capable of reversibly inserting lithium ions at the positive electrode is preferably a material that has an electrochemical potential of greater than 2 V relative to the lithium couple, and it is advantageously chosen from
transition metal oxides of spinel structure of the type LiM₂O₄ and transition metal oxides of lamellar structure of the type LiMO₂ in which M represents at least one metal chosen from the group formed by Mn, Fe, Co, Ni, Cu, Mg, Zn, V, Ca, Sr, Ba, Ti, Al, Si, B and Mo;
oxides of polyanionic architecture of the type LiM_{y}(XO_{z})ₙ in which M represents at least one metal chosen from the group formed by Mn, Fe, Co, Ni, Cu, Mg, Zn, V, Ca, Sr, Ba, Ti, Al, Si, B and Mo and X represents an element chosen from the group formed by P, Si, Ge, S and As;
oxides based on vanadium.

Among the oxides of spinel structure of the type LiM₂O₄, the ones that are preferred are those in which M represents at least one metal chosen from Mn and Ni. Among the oxides of lamellar structure of the type LiMO₂, the ones that are preferred are those in which M represents at least one metal chosen from Mn, Co and Ni. Among the oxides of polyanionic architecture of the type LiM_{y}(XO_{z})ₙ, phosphates of olivine structure are preferred in particular, the composition of which corresponds to the formula LiMPO₄ in which M represents at least one element chosen from Mn, Fe, Co and Ni. LiFePO₄ is preferred.

The electrolyte is formed from a lithium salt dissolved in a solvent chosen so as to optimize the ion transport and dissociation. The lithium salt may be chosen from LiPF₆, LiAsF₆, LiClO₄, LiBF₄, LiC₄BO₈ Li(C₂F₅SO₂)₂N, Li[(C₂F₅)₃PF₃], LiCF₃SO₃, LiCH₃SO₃, LiN(SO₂CF₃)₂ and LiN(SO₂F)₂.

The solvent may be a liquid solvent comprising one or more polar aprotic compounds chosen from linear or cyclic carbonates, linear or cyclic ethers, linear or cyclic esters, linear or cyclic sulfones, sulfamides and nitriles. The solvent is preferably formed from at least two carbonates chosen from ethylene carbonate, propylene carbonate, dimethyl carbonate, diethyl carbonate and methyl and ethyl carbonate.

The solvent of the electrolyte may also be a solvating polymer. Examples of solvating polymers that may be mentioned include polyethers of linear, comb or block structure, optionally forming a network, based on poly(ethylene oxide); copolymers containing the ethylene oxide or propylene oxide or allyl glycidyl ether unit; polyphosphazenes; crosslinked networks based on polyethylene glycol crosslinked with isocyanates; copolymers of oxyethylene and of epichlorohydrin as described in FR-9712952; and networks obtained by polycondensation and bearing groups that enable the incorporation of crosslinkable groups. Mention may also be made of block copolymers in which certain blocks bear functions that have redox properties. Needless to say, the above list is not limiting, and any polymer with solvating properties may be used.

The solvent of the electrolyte may also contain a mixture of a polar aprotic liquid compound chosen from the polar aprotic compounds mentioned above and a solvating polymer. It may comprise from 2% to 98% by volume of liquid, solvent, depending on whether or not an electrolyte plasticized with a small content of polar aprotic compound, or an electrolyte gelled with a high content of polar aprotic compound, is desired. When the polymer solvent of the electrolyte bears ionic functions, the lithium salt is optional.

The solvent of the electrolyte may also contain a nonsolvating polar polymer comprising units containing at least one heteroatom chosen from sulfur, oxygen, nitrogen and fluorine. Such a nonsolvating polymer may be chosen from acrylonitrile homopolymers and copolymers, fluorovinylidene homopolymers and copolymers, and N-vinyl pyrrolidone homopolymers and copolymers. The nonsolvating polymer may also be a polymer bearing ionic substituents, and especially a polyperfluoroether sulfonate salt (for instance the above-mentioned Nafion®) or a polystyrene sulfonate salt. When the electrolyte contains a nonsolvating polymer, it is necessary for it also to contain at least one polar aprotic compound as defined previously or at least one solvating polymer as defined previously.

The present invention is illustrated by the examples below, to which it is not, however, limited.

In the examples, the following were used:
nanometric silicon in the form of particles with a mean size of 100 nm and a purity of 99.999%, supplied by the company Alfa Aesar;
micrometric silicon in the form of particles with a mean size of 5 μm and a purity of 99.999%, supplied by the company Alfa Aesar;
a carboxymethylcellulose CMC with a degree of substitution of the protons with groups CH₂CO₂Na (DS) of 0.7 and a weight-average molar mass Mw of 90 000, supplied by the company Aldrich.

### EXAMPLE 1

### Preparation of a Battery

### Preparation of an Initial Composition

A buffered acidic solution at pH 3 was prepared by dissolving in 100 ml of water 3.842 g of citric acid and 0.402 g of KOH. The buffer concentration of this solution is noted as T. 160 mg of nanometric silicon, 16 mg of CMC and 24 mg of acetylene black were dispersed in 0.5 ml of this solution. Dispersion was performed using a ball mill (Pulverisette 7 Fritsch) with a 12.5 ml milling bowl containing 3 balls 10 mm in diameter, for 1 hour at 500 rpm.

The initial composition thus obtained is formed by 72.4% by mass of silicon particles, 7.2% by mass of CMC binder, 10.8% by mass of acetylene black, 8.7% by mass of citric acid and 0.9% by mass of KOH.

### Preparation of an Electrode

The total amount of the initial composition was applied to a copper current collector 25 μm thick and with a surface area of 10 cm². Drying was then performed at room temperature for 12 hours, and then at 100° C. under vacuum for 2 hours. In the electrode thus obtained, the layer of composite material deposited on the current collector has a thickness of 10-20 μm, which corresponds to an amount of silicon of 1-2 mg/cm². The composite material obtained after drying has the following composition:
72.4% by mass of silicon particles;
7.2% by mass of CMC binder;
10.8% by mass of acetylene black;
8.7% by mass of citric acid and 0.9% by mass of KOH.

### Assembly of a Battery

The electrode thus obtained was mounted in a battery (referred to as battery D) having as positive electrode a sheet of lithium metal laminated on a nickel current collector, a glass fiber separator, a liquid electrolyte formed from a 1 M LiPF₆ solution dissolved in a mixture of ethylene carbonate (EC) and dimethyl carbonate (DMC), 1/1 EC/DMC.

Three other batteries were assembled according to the same procedure, but using micrometric silicon and a buffered pH (battery B), nanometric silicon at pH 7 (battery C) and micrometric silicon at pH 7 (battery A). The data concerning the various batteries are collated in the table below. The amounts are given as weight percentages.

| | | | Acetylene | | | |
|---|---|---|---|---|---|---|
| | Si | CMC | black | Citric acid | KOH | pH |
| D | 72.4 nanometric | 7.2 | 10.8 | 8.7 | 0.9 | 3 buffered |
| B | 72.4 micrometric | 7.2 | 10.8 | 8.7 | 0.9 | 3 buffered |
| C | 80 nanometric | 8 | 12 | — | — | 7 |
| A | 80 micrometric | 8 | 12 | — | — | 7 |

### EXAMPLE 2

### Cycling of the Batteries, with Limitation of the Specific Capacitance

The cycling performance of the 4 batteries assembled according to the procedure of Example 1 were evaluated in cycling. Cycling was performed at a constant specific capacitance limited to 1200 mAh/g of Si in the potential range 0-1 V vs. Li+/Li. It was run in galvanostatic current mode at a current I of 900 mA/g, which corresponds to a regime of C, according to which each charging and each discharging takes place in 1 hour.

FIG. 1 shows the change in capacitance and in Faraday yield in the course of the charging/discharging cycles, during cycling of the battery (D) according to the invention. The specific capacitance SC in mAh/g and the percentage coulombic efficacy are given as a function of the cycle number N. The respective curves are as follows:
▪ SC during discharging,
□ SC during charging,
⋄ Faraday yield.

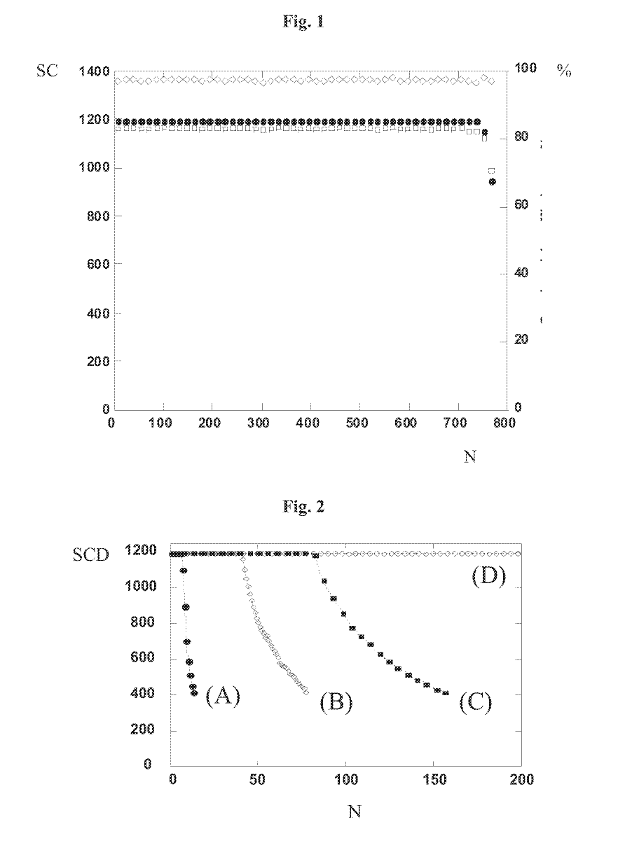

FIG. 2 compares the change in the specific capacitance on discharging (SCD in mA/h) as a function of the number N, during cycling of the batteries (A), (B), (C) and (D). It shows the substantial improvement afforded by a pH buffered at 3 relative to a pH of 7, both for the micrometric particles and for the nanometric particles. The correspondence between the curves and the batteries is as follows:
∘ battery D
▪ battery C
⋄ battery B
battery A

### EXAMPLE 3

### Cycling of the Batteries without Limitation of the Specific Capacitance

The cycling performance of the 4 batteries assembled according to the procedure of Example 1 were evaluated in cycling without limitation of capacitance, in the potential range 0-1 V vs. Li+/Li. The cycling was run in galvanostatic current mode at a current I of 120 mA/g, which corresponds to a regime of C/7.5, according to which each charging and each discharging takes place in 7.5 hours.

FIG. 3 compares the change in the specific capacitance on discharging (SCD in mA/h) as a function of the number N, during cycling of the batteries (A), (B), (C) and (D). These results show the substantial improvement afforded by a pH buffered at 3 relative to a pH of 7 both for the micrometric particles and for the nanometric particles.

The correspondence between the curves and the batteries is as follows:
Δ battery D
▴ battery C
□ battery B
▪ battery A.

### EXAMPLE 4

### Cycling of the Batteries, with Limitation of the Specific Capacitance

In this example, the batteries were prepared at acidic pH, by using a strong acid H₂SO₄ and not a buffer. The batteries thus prepared were studied in cycling, with limitation of the capacitance, according to the protocol detailed below.

### Preparation of an Initial Composition

An unbuffered acidic solution at pH 1 was prepared by dissolving the appropriate amount of sulfuric acid in 100 ml of water. 160 mg of nanometric silicon, 16 mg of CMC and 24 mg of acetylene black were dispersed in 0.5 ml of this solution. Dispersion was performed using a ball mill (Pulverisette 7 Fritsch) with a 12.5 nil milling bowl containing 3 balls 10 mm in diameter, for 1 hour at 500 rpm.

### Preparation of an Electrode

The total amount of the initial composition was applied to a copper current collector 25 μm thick with a surface area of 10 cm². Drying was then performed at room temperature for 12 hours, and then at 100° C. under vacuum for 2 hours. In the electrode thus obtained, the layer of composite material deposited on the current collector has a thickness of 10-20 μm, which corresponds to an amount of silicon of 1-2 mg/cm².

### Assembly of a Battery

The electrode thus obtained (designated as battery E) was mounted in batteries having as positive electrode a sheet of lithium metal laminated on a nickel current collector, a glass fiber separator, a liquid electrolyte formed from a 1 M LiPF₆ solution dissolved in a mixture of ethylene carbonate (EC) and dimethyl carbonate (DMC), 1/1 EC/DMC.

Two other batteries were assembled according to the same procedure, but using an unbuffered sulfuric acid solution at pH2 (battery F) and an unbuffered sulfuric acid solution at pH 3 (battery G). The data concerning the various batteries are collated in the table below. The amounts are given in weight percentages.

| | Nanometric Si | CMC | Acetylene black | Sulfuric acid | pH |
|---|---|---|---|---|---|
| E | 78.1 | 7.8 | 11.7 | 2.4 | 1 |
| F | 79.8 | 7.98 | 11.97 | 0.24 | 2 |
| G | 79.98 | 7.99 | 11.99 | 0.024 | 3 |

Cycling of the Batteries with Limitation of the Specific Capacitance

The cycling performance of the 3 assembled batteries was evaluated in cycling. Cycling was performed at a constant specific capacitance limited to 1200 mAh/g of Si in the potential range 0-1 V vs. Li+/Li. It was run in galvanostatic current mode at a current I of 900 mA/g, which corresponds to a regime of C, according to which each charging and each discharging takes place in 1 hour.

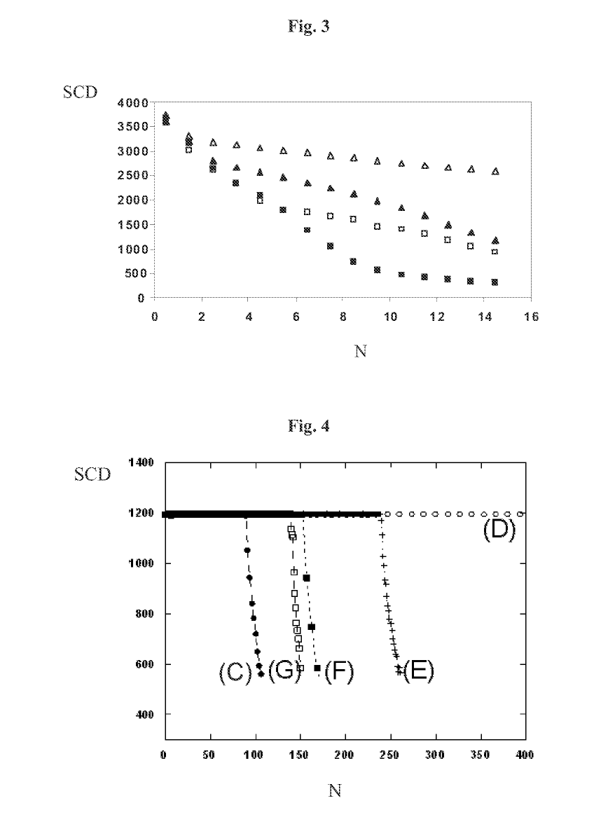

FIG. 4 compares the change in specific capacitance on discharging (SC) in mA/h) as a function of the number N, during cycling of the batteries (E), (F), (G) and (A). Compared with the preparation process without modification of the pH, acidification leads to an improvement in performance, in the following order pH 1>pH 2>pH 3>pH 7. The correspondence between the curves and the batteries is as follows:
+ battery E
▪ battery F
□ battery G
battery C
∘ battery D

Comparison of FIG. 4 with FIG. 1 shows that the best performance is, however, obtained using a mixture of citric acid and a strong base for buffering at pH 3 (battery D of Example 1).

### EXAMPLE 5

### Cycling of the Batteries, with Limitation of the Specific Capacitance

In this example, the batteries were prepared at acidic pH, by using a citric acid buffer and KOR Relative to the reference concentration T used above in Example 1, the buffer concentration was varied to take the following values: T/10, T/4, T/2, 3T/4, 3T/2, 2T.

### Preparation of an Initial Composition

A buffered acidic solution at pH 3 was prepared by dissolving in 100 ml of water 0.3842 g of citric acid and 0.0402 g of KOH. The buffer concentration of this solution is noted as T/10, since it is equal to 1/10 of the buffer concentration of the solution prepared in Example 1 whose concentration T was noted. 160 mg of nanometric silicon, 16 mg of CMC and 24 mg of acetylene black were dispersed in 0.5 ml of this solution T/1.0. Dispersion was performed using a ball mill (Pulverisette 7 Fritsch) with a 12.5 ml milling bowl containing 3 balls 10 mm in diameter, for 1 hour at 500 rpm.

The initial composition thus obtained is formed by 79.83% by mass of silicon particles, 7.98% by mass of CMC binder, 11.97% by mass of acetylene black, 0.19% by mass of citric acid and 0.02% by mass of KOH.

### Preparation of an Electrode

The total amount of the initial composition was applied to a copper current collector 25 μm thick with a surface area of 10 cm². Drying was then performed at room temperature for 12 hours, and then at 100° C. under vacuum for 2 hours. In the electrode thus obtained, the layer of composite material deposited on the current collector has a thickness of 10-20 μm, which corresponds to an amount of silicon of 1-2 mg/cm². The composite material obtained after drying has the following composition:
79.2% by mass of silicon particles;
7.9% by mass of CMC binder;
11.9% by mass of acetylene black;
1.0% by mass of citric acid and 0.1% KOH.

### Assembly of a Battery

The electrode thus obtained was mounted in a battery (denoted as battery H) having as positive electrode a sheet of lithium metal laminated on a copper current collector, a glass fiber separator, a liquid electrolyte formed from a 1 M LiPF₆ solution dissolved in a mixture of ethylene carbonate (EC) and dimethyl carbonate (DMC), 1/1 EC/DMC.

Five other batteries were assembled according to the same procedure, but using a buffer solution of concentration T/4 (battery I), T/2 (battery J), 3T/4 (battery K), 3T/2 (battery L) and 2T (battery M). The data concerning the various batteries are collated in the table below.

| | Buffer | Nanometric | | Acetylene | Citric | | Buffered | Q | R |
|---|---|---|---|---|---|---|---|---|---|
| | concentration | Si | CMC | black | acid | KOH | pH | (×10⁴) | (%) |
| H | T/10 | 79.2 | 7.9 | 11.9 | 1.0 | 0.1 | 3 | 0.62 | 1.1 |
| I | T/4 | 77.8 | 7.8 | 11.7 | 2.3 | 0.2 | 3 | 1.56 | 2.6 |
| J | T/2 | 76.0 | 7.6 | 11.4 | 4.6 | 0.5 | 3 | 3.12 | 5.0 |
| K | 3T/4 | 74.1 | 7.4 | 11.1 | 6.7 | 0.7 | 3 | 4.69 | 7.4 |
| D | T | 72.3 | 7.2 | 10.8 | 8.7 | 0.9 | 3 | 6.25 | 9.6 |
| L | 3T/2 | 69 | 6.9 | 10.4 | 12.4 | 1.3 | 3 | 9.38 | 13.7 |
| M | 2T | 66 | 6.6 | 9.9 | 15.9 | 1.7 | 3 | 12.51 | 17.5 |

In this table, the amounts are given in weight percentages; the amount of organic acid in moles per gram of element M is noted as Q; the mass ratio is noted as R:

$$\frac{organic acid + strong base}{\begin{matrix}organic acid + strong base + M + binder + \\ electron \text{-} conducting agent\end{matrix}} .$$

The performance of battery H was evaluated in cycling. Cycling was performed at a constant specific capacitance limited to 1200 mAh/g of Si in the potential range 0-1 V vs. Li+/Li. It was run in galvanostatic current mode at a current I of 900 mA/g, which corresponds to a regime of C, according to which each charging and each discharging takes place in 1 hour.

The table below gives, for each of the batteries tested, the real capacitance mAh/g of electrode, the number of cycles at constant specific capacitance sustained by each battery and the mean Faraday yield during the charging/discharging cycles, during cycling of the battery (FE) and of batteries (I), (J), (K), (D, Example 1), (L) and (M) according to the invention and A (neutral pH, unmodified).

| | | Real | | Mean |
|---|---|---|---|---|
| | Specific | capacitance | Number | Faraday |
| | capacitance | (mAh/g of | of | yield |
| | (mAh/g of Si) | electrode) | cycles | (%) |
| H | T/10 | 950 | 430 | 94 |
| I | T/4 | 935 | 470 | 95.5 |
| J | T/2 | 912 | 520 | 97.5 |
| K | 3T/4 | 889 | 600 | 98 |
| D | T | 868 | 700 | 98 |
| L | 3T/2 | 828 | 685 | 97.5 |
| M | 2T | 792 | 690 | 97.5 |

These results show that the amount of organic acid must be such that it corresponds to a content of greater than 0.510⁻⁴ mol per gram of element M, preferentially a content of greater than 5×10⁻⁴ mol per gram of element M, since below this value the improvement in performance is less interesting, and it is preferable for the mass ratio

$$\frac{organic acid + strong base}{\begin{matrix}organic acid + strong base + M + binder + \\ electron \text{-} conducting agent\end{matrix}}$$

to remain less than or equal to 10% since beyond this value no further significant improvement in performance is observed.

### EXAMPLE 6

### Cycling of the Batteries, with Limitation of the Specific Capacitance

In this example, the batteries were prepared at acidic pH, by using an organic acid buffer and KOH. The organic acid being: aspartic acid (buffer pH 2), aspartic acid (buffer pH 3.9). Another battery was prepared with the mineral acid phosphoric acid (buffer pH 3).

### Preparation of an Initial Composition

Buffered acidic solutions were prepared by dissolving in 100 ml of water a certain amount of organic acid or of mineral acid and a certain amount of KOH. 160 mg of nanometric silicon, 16 mg of CMC and 24 mg of acetylene black were dispersed in 0.5 ml of this solution. Dispersion was performed using a ball mill (Pulverisette 7 Fritsch) with a 12.5 ml milling bowl containing 3 balls 10 mm in diameter, for 1 hour at 500 rpm.

The acid is either the organic acid aspartic acid (buffer pH 2 or buffer pH 4) or the mineral acid phosphoric acid (buffer pH 3).

### Preparation of an Electrode

The total amount of the initial composition was applied to a copper current collector 25 μm thick with a surface area of 10 cm². Drying was then performed at room temperature for 12 hours and then at 100° C. under vacuum for 2 hours. In the electrode thus obtained, the layer of composite material deposited on the current collector has a thickness of 10-20 μm, which corresponds to an amount of silicon of 1-2 mg/cm².

### Assembly of a Battery

The electrodes thus obtained were mounted in a battery having as positive electrode a sheet of lithium metal laminated on a copper current collector, a glass fiber separator, a liquid electrolyte formed from a 1 M LiPF₆ solution dissolved in a mixture of ethylene carbonate (EC) and dimethyl carbonate (DMC), 1/1 EC/DMC.

The data concerning the various batteries are collated in the table below. The amounts are given as weight percentages.

| | | | | Acetylene | | |
|---|---|---|---|---|---|---|
| | Acid | Nanometric Si | CMC | black | Buffer composition | pH |
| N | aspartic | 78.68 | 7.86 | 11.8 | Aspartic acid 1.63; | 2 buffered |
| | | | | | H₂SO₄: 0.024 | |
| O | aspartic | 78.34 | 7.83 | 11.75 | Aspartic acid 1.62; | 4 buffered |
| | | | | | KOH = 0.44 | |
| P | phosphoric | 64.59 | 6.45 | 9.69 | H₃PO₄ = 1.97; | 3 buffered |
| | | | | | NaH₂PO₄ = 17.27 | |

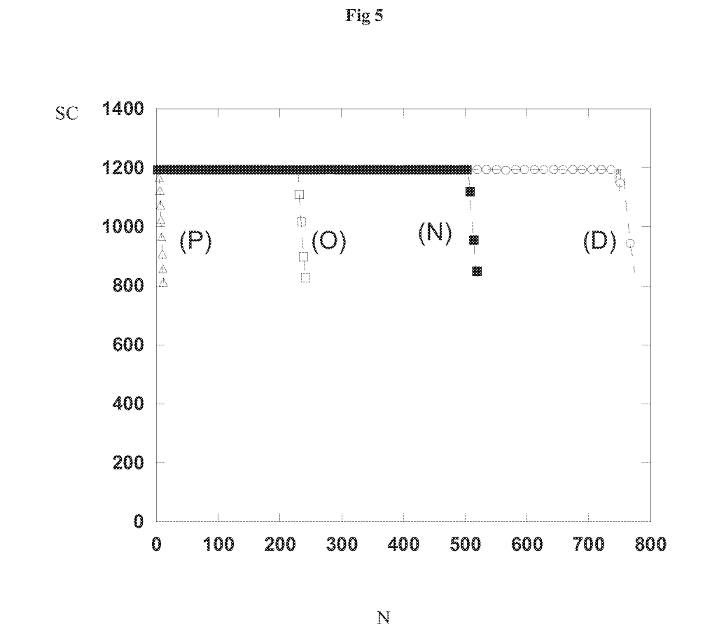

FIG. 5 compares the change in specific capacitance on discharging (SCD in mA/h) as a function of the number N, during cycling of batteries (D), (N), (O) and (P).

The correspondence between the curves and the batteries is as follows:
∘ battery D
▪ battery N
□ battery O
▴ battery P

This example thus shows that the pH value of less than or equal to 4 is indeed an upper limit for the pH value when it is buffered. These results also show that the use of a mineral acid (H₃PO₄) does not afford any improvement, in contrast with the use of an organic acid.

### EXAMPLE 7

In this example, a battery was prepared according to Example 1, the difference being that the drying temperature is not 100° C., but 150° C.

### Preparation of a Battery

The preparation of the battery of this example is identical to that of Example 1, the only difference being the drying temperature, which is 150° C.

### Preparation of an Electrode

The total amount of the initial composition was applied to a copper current collector 25 μm thick with a surface area of 10 cm². Drying was then performed at room temperature for 12 hours and then at 100° C. under vacuum for 2 hours. In the electrode thus obtained, the layer of composite material deposited on the current collector has a thickness of 10-20 μm, which corresponds to an amount of silicon of 1-2 mg/cm². The composite material obtained after drying has the following composition:
72.4% by mass of silicon particles;
7.2% by mass of CMC binder;
10.8% by mass of acetylene black,
8.7% by mass of citric acid and 0.9 of KOH

### Assembly of a Battery

The electrode thus obtained was mounted in a battery (denoted as battery Q) having as positive electrode a sheet of lithium metal laminated on a nickel current collector, a glass fiber separator, a liquid electrolyte formed from a 1 M LiPF₆ solution dissolved in a mixture of ethylene carbonate (EC) and dimethyl carbonate (DMC), 1/1 EC/DMC.

Cycling of the Battery with Limitation of the Specific Capacitance

The cycling performance of the battery was evaluated in cycling. Cycling was performed at a constant specific capacitance limited to 1200 mAh/g of Si in the potential range 0-1 V vs. Li+/Li. It was run in gaivanostatic current mode at a current I of 900 mA/g, which corresponds to a regime of C, according to which each charging and each discharging takes place in 1 hour.

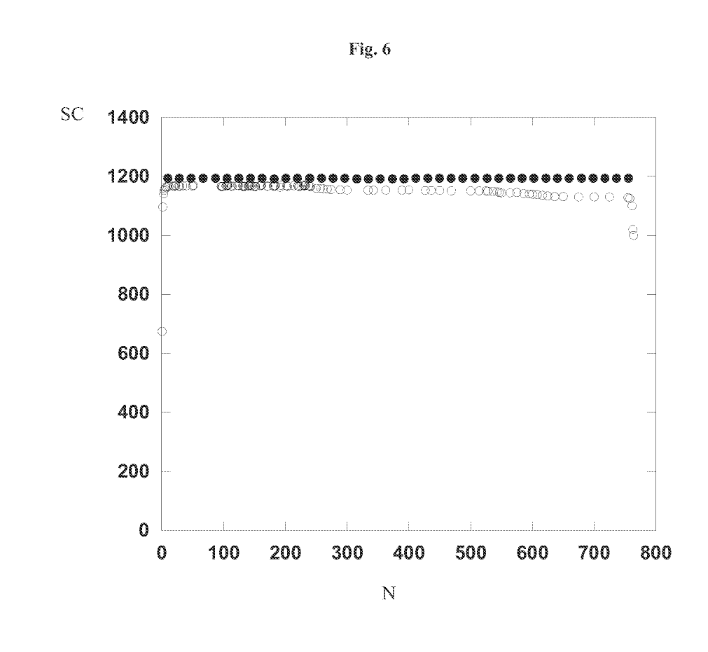

FIG. 6 shows the change in capacitance and a Faraday yield in the course of the charging/discharging cycles, during cycling of the battery (D) according to the invention. The specific capacitance SC in mAh/g is given as a function of the cycle number N. The respective curves are as follows:
SC during discharging,
∘ SC during charging.

The results presented in this example show that the drying temperature has no effect on the electrochemical performance.

1. A process for preparing a negative electrode composition, comprising a step of suspending in an aqueous medium an electrode active material, a binder and an agent for generating electron conductivity, wherein:
the electrode active material is in the form of particles containing an element M is selected from the group consisting of Si, Sn, Ge; said particles having a mean size of less than 1 μm;
the binder is a polymer that bears reactive groups capable of reacting with hydroxyl groups in acidic medium;
the aqueous medium is an unbuffered acidic medium at pH 1, or a buffered acidic medium at a pH of less than or equal to 4, obtained by adding a strong base and an organic acid;
the total amount of “active material, binder, electron-conducting agent” constituents introduced into the acidic aqueous medium is from 10% to 80% by weight of the total amount of the composition, and the proportions of said constituents in the aqueous medium are as follows:
30% to 90% by weight of particles of active material;
5% to 40% by weight of binder;
5% to 30% by weight of electron conductivity agent;
the amount of organic acid is such that it corresponds to a content of greater than 0.5×10⁻⁴ mol per gram of element M, and the mass ratio
$$\frac{organic acid + strong base}{\begin{matrix}organic acid + strong base + M + binder + \\ electron \text{-} conducting agent\end{matrix}}$$
remains less than or equal to 20%.

2. The process as claimed in claim 1, wherein the active material particles have a mean size of less than 200 nm.

3. The process as claimed in claim 1, wherein the active material particles are formed by an element M alone, an alloy of M with Li, or with a composite material comprising the element M or the alloy M-Li and a conductive material Q.

4. The process as claimed in claim 3, wherein the conductive material Q is formed by carbon or by a metal that does not react with lithium.

5. The process as claimed in claim 1, wherein the polymeric binder is a polymer that is electrochemically stable in the potential window 0-5 V relative to Li⁰/Li⁺, insoluble in the liquid media that may be used as liquid electrolyte solvent, and which bears functions that are capable of reacting with OH groups in acidic medium.

6. The process as claimed in claim 5, wherein the polymer is selected from the group consisting of acrylic acid copolymers, acrylamide copolymers, styrenesulfonic acid copolymers, maleic acid copolymers, itaconic acid copolymers, lignosulfonic acid copolymers, allylamine copolymers, ethacrylic acid copolymers, polysiloxanes, epoxyamine polymers, polyurethanes and carboxymethylcelluloses.

7. The process as claimed in claim 1, wherein the agent for generating electron conductivity is selected from the group consisting of carbon black, SP carbon, acetylene black, carbon nanofibers and carbon nanotubes.

8. The process as claimed in claim 1, wherein the amount of organic acid is such that it corresponds to a content of greater than 5×10⁻⁴ mol per gram of element M and the mass ratio
$$\frac{organic acid + strong base}{\begin{matrix}organic acid + strong base + M + binder + \\ electron \text{-} conducting agent\end{matrix}}$$
remains less than or equal to 10%.

9. The process as claimed in claim 1, wherein the total amount of “active material, binder and electron-conducting agent” constituents introduced into the acidic aqueous medium is from 20% to 60% by weight relative to the total weight of the composition.

10. The process as claimed in claim 1, wherein the strong base is an alkali metal hydroxide and the organic acid is selected from the group consisting of glycine, aspartic acid, bromoethanoic acid, bromobenzoic acid, chloroethanoic acid, dichloroethanoic acid, trichloroethanoic acid, lactic acid, maleic acid, malonic acid, phthalic acid, isophthalic acid, terephthalic acid, picric acid, salicylic acid, formic acid, acetic acid, oxalic acid, malic acid, fumaric acid and citric acid.

11. A negative electrode composition obtained as claimed in claim 1, wherein said negative electrode composition comprises:
an electrode active material in the form of particles containing an element M selected from the group consisting of Si, Sn, Ge; said particles having a mean size of less than 1 μm;
a polymeric binder that bears reactive groups that are capable of reacting with hydroxyl groups in acidic medium;
an agent that imparts electron conductivity;
an unbuffered acidic aqueous medium at pH 1, or an acidic medium at a buffered pH of less than or equal to 4 obtained by adding a strong base and an organic acid;
and in that:
the total amount of “active material, binder, electron-conducting agent” constituents introduced into the acidic aqueous medium is from 10% to 80% by weight of the total amount of the composition, and the proportions of said constituents in the aqueous medium are as follows:
30% to 90% by weight of active material particles;
5% to 40% by weight of binder;
5% to 30% by weight of electron conductivity agent,
the amount of organic acid is such that it corresponds to a content of greater than 0.5×10⁻⁴ mol per gram of element M, and the mass ratio
$$\frac{organic acid + strong base}{\begin{matrix}organic acid + strong base + M + binder + \\ electron \text{-} conducting agent\end{matrix}}$$
remains less than or equal to 20%.

12. The negative electrode composition as claimed in claim 11, wherein the active material particles have a mean size of less than 200 nm.

13. A negative electrode formed by a negative electrode composition as defined in claim 11 on a conductive substrate.

14. The electrode as claimed in claim 13, wherein the active material particles are silicon particles.

15. A battery that comprises at least one negative electrode and at least one positive electrode between which is placed a solid electrolyte or a separator impregnated with a liquid electrolyte, wherein the negative electrode is an electrode as claimed in claim 13.

16. A battery that comprises at least one negative electrode and at least one positive electrode between which is placed a solid electrolyte or a separator impregnated with a liquid electrolyte, wherein the negative electrode is an electrode as claimed in claim 14.

17. A negative electrode formed by a negative electrode composition as defined in claim 12 on a conductive substrate.

18. The electrode as claimed in claim 17, wherein the active material particles are silicon particles.

19. A battery that comprises at least one negative electrode and at least one positive electrode between which is placed a solid electrolyte or a separator impregnated with a liquid electrolyte, wherein the negative electrode is an electrode as claimed in claim 17.

20. A battery that comprises at least one negative electrode and at least one positive electrode between which is placed a solid electrolyte or a separator impregnated with a liquid electrolyte, wherein the negative electrode is an electrode as claimed in claim 18.
